(19) United States
(12) Patent Application Publication
(10) Pub. No.: US 2016/0002088 A1
(43) Pub. Date: Jan. 7, 2016

(54) LASER PROCESSING APPARATUS AND LASER PROCESSING METHOD

(71) Applicant: V TECHNOLOGY CO., LTD., Kanagawa (JP)

(72) Inventors: Michinobu Mizumura, Kanagawa (JP); Masami Takimoto, Kanagawa (JP); Shota Matsuyama, Kanagawa (JP)

(73) Assignee: V TECHNOLOGY CO., LTD., Kanagawa (JP)

(21) Appl. No.: 14/765,233

(22) PCT Filed: Feb. 3, 2014
(86) PCT No.: PCT/JP2014/052420

§ 371 Date: Jul. 31, 2015

(30) Foreign Application Priority Data
Feb. 5, 2013 (JP) 2013-020940

(51) Int. Cl. C03B 33/10; G02B 7/02; C03C 23/00; G02B 19/00

(52) U.S. Cl. CPC C03B 33/102; G02B 19/0009; G02B 7/02; C03C 23/0025

(57) ABSTRACT

A laser processing apparatus that condenses a laser beam into an annular shape to irradiate the condensing position of the laser beam within a thickness range of a substrate, and shifts the condensing position in such a manner that the center of the condensing position that is annular moves in a circular manner, at a stage of shifting the condensing position in a thickness direction of the substrate and a planar direction of the substrate.

### TECHNICAL FIELD

One or more embodiments of the invention relate to a laser processing apparatus and a laser processing method for performing a through-hole process on a substrate such as a glass substrate.

### BACKGROUND

A glass substrate with a thickness of 1 mm or less has recently been used on the display screen of a portable information terminal, such as, mainly, a Smartphone. A through-hole process is performed on the glass substrate so as to accommodate functions such as various buttons and a microphone. One of the problems that arise in performing this through-hole process on such a thin, brittle material as a glass substrate is a yield decline resulting from cracks formed during the process. Especially when forming a relatively large hole of approximately 10 mm in diameter to create the home button hole on the screen of the portable information terminal, the circular hole is formed by making a circular scratch on the surface using a glass cutter with a diamond edge, further making scratches in a lattice pattern or the like on the inside of the circular scratch, and gradually expanding the opening by striking the scratches. In actuality, however, artificially striking the scratches has a great impact on the processing accuracy, and a yield decline resulting from cracks is somewhat inevitable.

On the other hand, various laser processing technologies using brittle materials such as glass have been proposed. Patent Literature 1 describes forming extremely small through-holes on a piece of glass by means of a YAG laser. Patent Literature 2 describes running a laser beam multiple times along, and on the inside of, the contour of a round hole, to form a round through-hole on a thin glass substrate.

### RELATED ART LITERATURE

### Patent Literature

Patent Literature 1: Japanese Unexamined Patent Application Publication No. 2000-61667

Patent Literature 2: Japanese Unexamined Patent Application Publication No. 2009-269057

### SUMMARY OF INVENTION

In laser processing where a through-hole process is executed by irradiating a brittle material such as a glass substrate with a laser beam, an extremely small through-hole with a diameter of 1 mm or less can be formed by setting the irradiation energy of the YAG laser at a predetermined threshold or higher and setting the condensing position of the laser at or below a position in the middle of the thickness of the processed substrate (see Patent Literature 1). In order to process a relatively large hole of approximately 10 mm in diameter, on the other hand, the laser beam needs to be run along the contour of the hole as described in Patent Literature 2, which means that an expensive scanning unit such as a galvanometer mirror is required, increasing the cost of the apparatus and its processing time.

One or more embodiments of the invention aim to eliminate problems concerning a yield decline resulting from the formation of cracks and to reduce the cost of the apparatus and its processing time in order to form a relatively large through-hole in a brittle material such as a glass substrate.

A laser processing apparatus and a laser processing method according to one or more embodiments of the invention have at least the following configurations.

A laser processing apparatus for performing a through-hole process on a substrate by irradiating the substrate with a laser beam, the laser processing apparatus including: a condensing lens that condenses the laser beam into an annular shape to irradiate a condensing position of the laser beam within a thickness range of the substrate; and a condensing position shifting unit that shifts the condensing position in a thickness direction of the substrate and a planar direction of the substrate.

A laser processing method for performing a through-hole process on a substrate by irradiating the substrate with a laser beam, the laser processing method including: condensing the laser beam into an annular shape to irradiate a condensing position of the laser beam within a thickness range of the substrate; and shifting the condensing position in such a manner that the center of the condensing position that is annular moves in a circular manner, at a stage of shifting the condensing position in a thickness direction of the substrate and a planar direction of the substrate.

### ADVANTAGEOUS EFFECTS OF INVENTION

According to one or more embodiments of the invention having the foregoing characteristics, by shifting, three-dimensionally, the condensing position of the annularly condensed laser beam within the thickness range of the substrate, the resultant laser-processing marks can be expanded simultaneously in the thickness direction and the radial direction in the entire circumference along the annular condensing position. As a result, the through-hole process on the substrate can promptly be completed with the simple configuration of the apparatus without using an expensive laser scanning unit.

Because the annular laser-processing marks are gradually expanded while being shifted, energy loss that occurs due to implementing repeated laser beam irradiation on the affected layer and resultant scattering can be minimized, resulting in an efficient through-hole process.

### BRIEF DESCRIPTION OF DRAWINGS

FIGS. 1(a) and 1(b) are explanatory diagrams showing an example of a condensing lens used in accordance with one or more embodiments of the invention.

FIGS. 2(a) and 2(b) are explanatory diagrams showing an operation of shifting the condensing position of a laser beam in accordance with one or more embodiments of the present invention.

FIG. 3 is an explanatory diagram showing an example of a laser processing apparatus according to one or more embodiments of the invention.

FIGS. 4(a) and 4(b) are explanatory diagrams showing a specific example of the laser processing apparatus in accordance with one or more embodiments of the invention.

FIG. 5 is an explanatory diagram showing a specific example of the laser processing apparatus according to one or more embodiments of the present invention.

### DESCRIPTION OF EMBODIMENTS

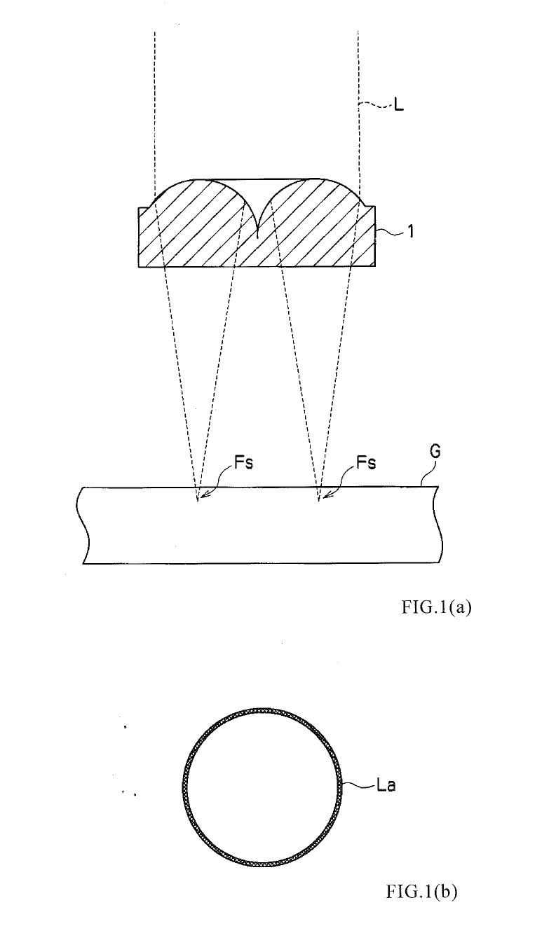

A laser processing apparatus and a laser processing method according tone or more embodiments of the invention are now described hereinafter with reference to the drawings. FIG. 1 is an explanatory diagram showing an example of a condensing lens used in one or more embodiments of the invention (FIG. 1(a) is a diagram showing the cross-sectional shape of the condensing lens and a condensed state of a laser beam, and FIG. 1(b) is a diagram planarly showing the shape of the annularly condensed laser beam). A condensing lens 1 condenses a laser beam L into an annular shape to irradiate a condensing position Fs of the laser beam L within a thickness range of a substrate G. The condensing lens 1 is basically an annular cylindrical lens, in which the laser beam L with a predetermined beam diameter and circular cross section enters an effective aperture, whereby an annularly condensed state La shown in FIG. 1(b) can be obtained.

The laser processing apparatus and laser processing method according to one or more embodiments of the invention each have a condensing position shifting unit that is configured in various ways as described hereinafter. The condensing position shifting unit uses the condensing lens 1 to shift the condensing position Fs, on which the laser beam L is condensed into an annular shape, in the thickness direction of the substrate G and the planar direction of the substrate G. As a result, the condensing position Fs of the laser beam L is changed three-dimensionally within the thickness range of the substrate G.

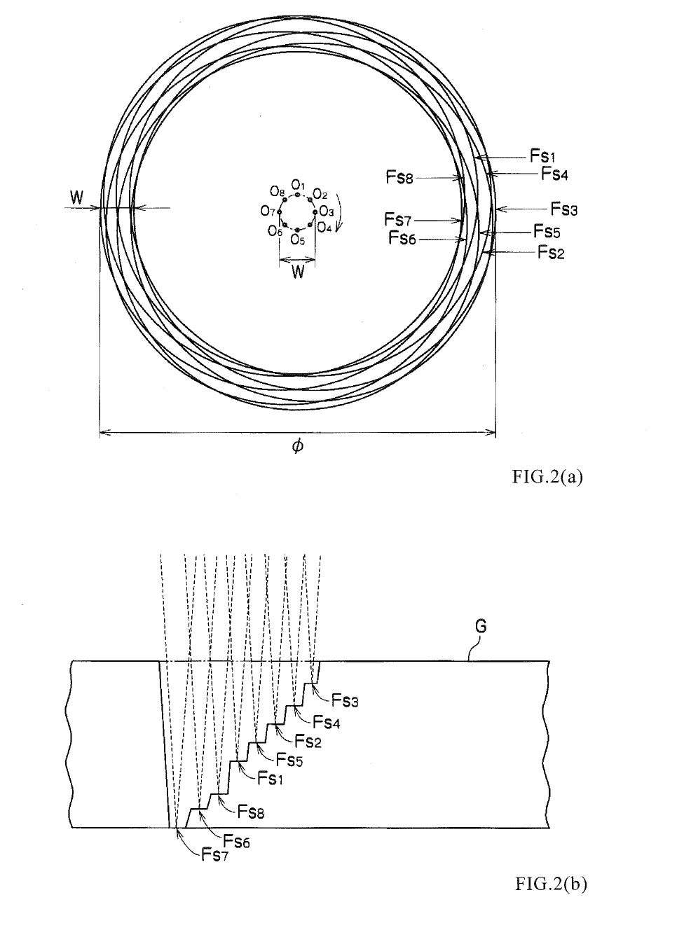

FIG. 2 is an explanatory diagram showing the operation of shifting the condensing position of the laser beam in accordance with one or more embodiments of the invention. FIG. 2(a) is a plan view of a movement of the condensing position, and FIG. 2(b) shows a movement of the condensing position in the thickness direction of the substrate. As shown in FIG. 2(a), the condensing position F_{S} (F_{S1}, F_{S2}, F_{S3}, F_{S4}, F_{S5}, F_{S6}, F_{S7}, F_{S8}) of the laser beam L is shifted planarly in such a manner that the center (O₁, O₂, O₃, O₄, O₅, O₆, O₇, O₈) of the condensing position Fs moves in a circular manner. Although the illustrated examples each show a circular moving trace of the center of the condensing position F_{S}, the shape of the moving trace is not limited to this perfect circle, and thus can be an elliptical shape or a deformed circular shape. The term “circular movement” may indicate a movement of the center that leaves a circular moving trace.

Let it be assumed that the moving trace of the center of the condensing position Fs is shaped into a circle with a diameter W. In this case, a laser-processing mark is formed within the range of the width W over the entire circumference of the annular condensing position F_{S}, and a laser-processing mark having a different depth in the thickness direction of the substrate G is formed as shown in FIG. 2(b) as a result of shifting the condensing position Fs in the thickness direction of the substrate G.

In this laser processing method according to one or more embodiments of the invention, at the stage of condensing the laser beam L into an annular shape and shifting the condensing position Fs thereof in the thickness direction of the substrate G and the planar direction of the substrate G, the annular condensing position Fs is shifted in such a manner that the center of the condensing position Fs moves in a circular manner. Accordingly, the condensing position Fs of the laser beam, condensed into an annular shape, is shifted three-dimensionally within the thickness range of the substrate G, whereby the laser-processing marks can be expanded simultaneously in a three-dimensional direction over the entire circumference along the annular condensing position F_{S}, promptly enabling the completion of the through-hole process of the substrate G. The laser-processing marks that are formed into an annular shape can gradually be expanded while being shifted, minimizing the energy loss that occurs due to implementing repeated laser beam irradiation on the affected layer and resultant scattering. As a result, an efficient through-hole process can be performed. The diameter φ of the through-hole to be formed is approximately 2R+W (where R represents the radius of the annular condensing position F_{S}).

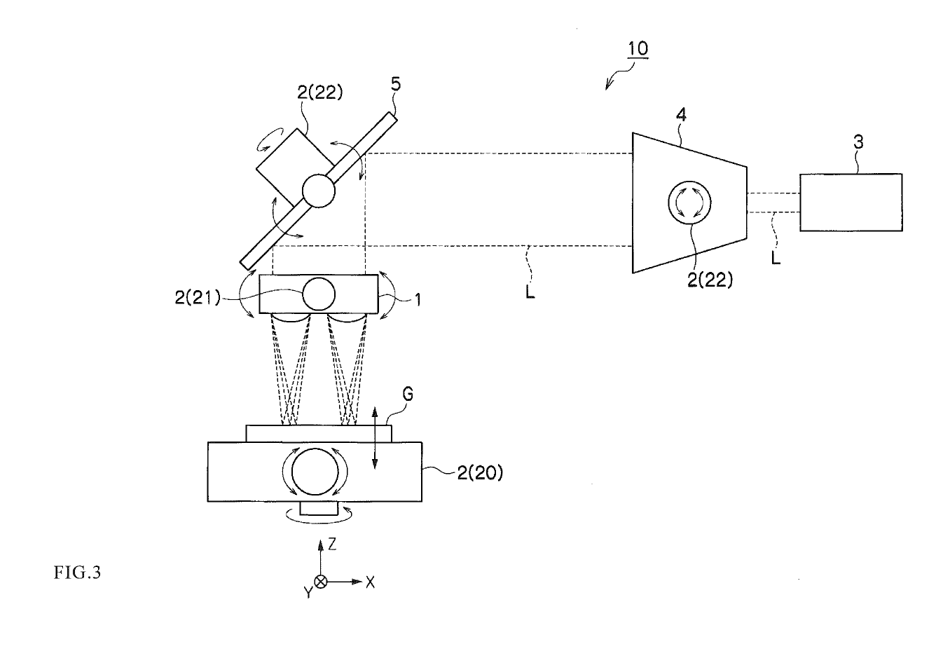

FIG. 3 is an explanatory diagram showing an example of the laser processing apparatus according to one or more embodiments of the invention. A laser processing apparatus 10 has the condensing lens 1 described above and a condensing position shifting unit 2 for shifting the condensing position Fs of the condensing lens 1 in the thickness direction of the substrate G and the planar direction of the substrate G. The laser processing apparatus 10 also has a laser source 3 for emitting the laser beam L and an optical system (a beam expander 4, a mirror 5, and the like) for guiding the laser beam L to the condensing lens 1.

According to one of the aspects of the condensing position shifting unit 2, the condensing position shifting unit 2 has a substrate moving unit 20 for moving the substrate G. The substrate moving unit 20 has a unit for moving the substrate G up and down in the thickness direction (the Z-axis direction) thereof, a unit for oscillating the substrate G about the horizontal axis (the X-axis or Y-axis), and a unit for rotating the substrate G about the vertical axis (the Z-axis), individually or in combination thereof. The substrate moving unit 20 may also have a unit for rotating the substrate G about a rotation axis that is inclined with respect to the axis perpendicular to the surface of the substrate G (Z-axis).

According to another aspect of the condensing position shifting unit 2, the condensing position shifting unit 2 has a condensing lens moving unit 21 for moving the condensing lens 1. The condensing lens moving unit 21 has a unit for oscillating the condensing lens 1 about the horizontal axis (the X-axis or Y-axis), a unit for rotating the condensing lens 1 about an optical axis of the laser beam L and the inclined rotation axis, and the like, individually or in combination thereof.

According to yet another aspect of the condensing position shifting unit 2, the condensing position shifting unit 2 has an optical element moving unit 22 for moving an optical element (e.g., the mirror 5 or beam expander 4) of the optical system that guides the laser beam L to the condensing lens 1. The optical element moving unit 22 has, for example, a unit for oscillating the angle of the mirror 5 for guiding the laser beam L to the condensing lens 1, a unit for rotating the mirror 5 about the axis perpendicular to the reflection surface of the mirror 5 and the inclined rotation axis, a unit for oscillating the beam expander 4 about the Y-axis, and the like, individually or in combination thereof.

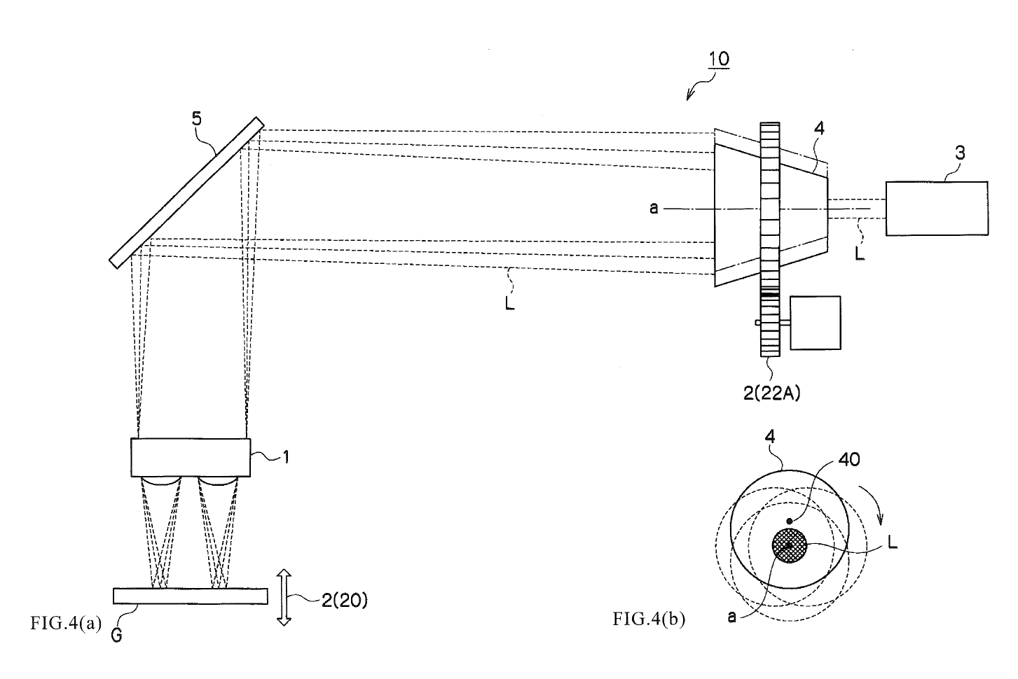

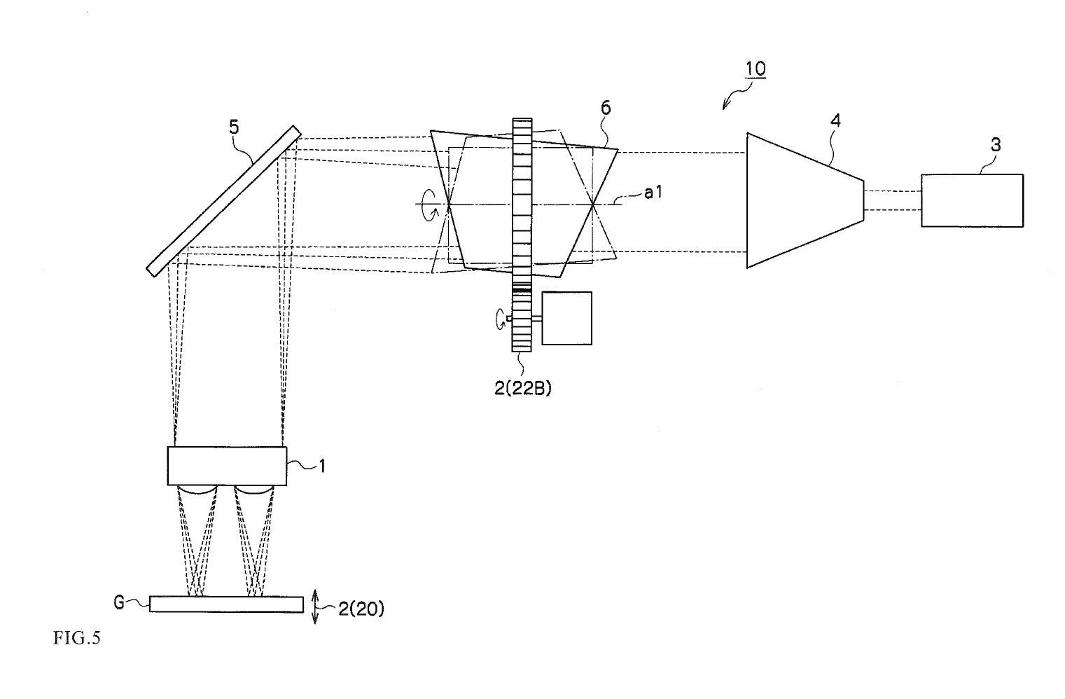

FIGS. 4 and 5 are explanatory diagrams each showing a specific example of the laser processing apparatus according to one or more embodiments of the invention. The laser processing apparatus 10 shown in FIG. 4 has the laser source 3, the beam expander 4 for expanding the beam diameter of the laser beam L emitted from the laser source 3, the mirror 5, and the condensing lens 1, as shown in FIG. 4(a), wherein the laser beam L, which is condensed into an annular shape by the condensing lens 1, is radiated to the substrate G. In one or more embodiments, an optical element moving unit 22A for rotating the beam expander 4 about a rotation axis a is provided as the condensing position shifting unit 2.

As shown in FIG. 4(b), this optical element moving unit 22A is provided with the rotation axis a at the position away from a center 40 of the beam expander 4, in which the rotation axis a coincides with the optical axis of the laser beam L. Rotating the beam expander 4 by means of the optical element moving unit 22A can achieve the same effects as radiating the laser beam L to a position deviating from the center 40 and moving the optical axis of the laser beam L in a circular manner around the center 40. As a result, the angle of the laser beam L that is emitted from the beam expander 4 and enters the condensing lens 1 can be changed, and consequently the condensing position Fs of the condensing lens 1 can be shifted in the thickness direction of the substrate G and the planar direction of the substrate G. Depending on the thickness of the substrate G, the substrate moving unit 2 (20) for moving the substrate G in the thickness direction may be provided in combination with the optical element moving unit 22A.

The laser processing apparatus 10 shown in FIG. 5 has the laser source 3, the beam expander 4 for expanding the beam diameter of the laser beam L emitted from the laser source 3, an image rotator (dove prism) 6, the mirror 5, and the condensing lens 1, in which the condensing lens 1 irradiates the substrate G with the laser beam L that is condensed into an annular shape. In one or more embodiments, an optical element moving unit 22B for rotating the image rotator (dove prism) 6 about a rotation axis al is provided as the condensing position shifting unit 2.

This optical element moving unit 22B rotates the image rotator 6 about the rotation axis al parallel to the optical axis of the laser beam L, the image rotator 6 being disposed at a tilt with respect to the optical axis Thus, the angle of the laser beam L that is emitted from the image rotator 6 and enters the condensing lens 1 can be changed, and the condensing position Fs of the condensing lens 1 can be shifted in the thickness direction of the substrate G and the planar direction of the substrate G. Depending on the thickness of the substrate G, the substrate moving unit 2 (20) for moving the substrate G in the thickness direction may be provided in combination with the optical element moving unit 22B.

The laser processing apparatus and laser processing method according to one or more embodiments of the invention may significantly prevent the formation of cracks during the laser processing as compared to the prior art where a glass cutter is used, and can realize high processing accuracy and yield regardless of the ability of the operator. In addition, unlike the prior art that runs a laser beam for scanning, the present invention may realize a relatively simple, inexpensive apparatus configuration by incorporating the condensing position shifting unit 2 that moves the substrate G, the condensing lens 1, or the optical element without using an expensive scanning unit such as a galvanometer mirror.

In addition, gradually expanding the annular laser-processing marks while changing the positions thereof can reduce the energy loss that occurs as a result of the laser beam being repeatedly radiated on the affected layer and scattering, realizing an efficient through-hole process and thereby enabling a reduction in the processing time thereof.

The above has described in detail the embodiments of the present invention with reference to the drawings. However, the specific configuration of the present invention is not limited thereto, and therefore the present invention includes changes in design that are made within the scope of the present invention. The foregoing embodiments can be combined by mutual application of the techniques thereof as long as no inconsistencies or problems are present in the objectives, configurations and so forth thereof.

### EXPLANATION OF REFERENCE NUMERALS

1: Condensing lens, 2: Condensing position shifting unit,
20: Substrate moving unit, 21: Condensing lens moving unit,
22, 22A, 22B: Optical element moving unit,
3: Laser source, 4: Beam expander, 5: Mirror
6: Image rotator (dove prism)
G: Substrate, L: Laser beam, F_{S} (F_{S1} to F_{S8}): Condensing position

1. A laser processing apparatus for performing a through-hole process on a substrate by irradiating the substrate with a laser beam, the laser processing apparatus comprising:
a condensing lens that condenses the laser beam into an annular shape to irradiate a condensing position of the laser beam within a thickness range of the substrate; and
a condensing position shifting unit that shifts the condensing position in a thickness direction of the substrate and a planar direction of the substrate.

2. The laser processing apparatus according to claim 1, wherein the condensing position shifting unit shifts the condensing position in such a manner that a center of the condensing position that is annular moves in a circular manner.

3. The laser processing apparatus according to claim 1, wherein the condensing position shifting unit has a substrate moving unit that moves the substrate.

4. The laser processing apparatus according to claim 1, wherein the condensing position shifting unit has a condensing lens moving unit that moves the condensing lens.

5. The laser processing apparatus according to claim 1, further comprising:
a laser source that emits the laser beam; and
an optical system that guides the laser beam emitted from the laser source to the condensing lens,
wherein the condensing position shifting unit has an optical element moving unit that moves an optical element of the optical system.

6. A laser processing method for performing a through-hole process on a substrate by irradiating the substrate with a laser beam, the laser processing method comprising:
condensing the laser beam into an annular shape to irradiate a condensing position of the laser beam within a thickness range of the substrate; and
shifting the condensing position in such a manner that a center of the condensing position that is annular moves in a circular manner, at a stage of shifting the condensing position in a thickness direction of the substrate and a planar direction of the substrate.

7. The laser processing apparatus according to claim 2, wherein the condensing position shifting unit has a substrate moving unit that moves the substrate.

8. The laser processing apparatus according to claim 2, wherein the condensing position shifting unit has a condensing lens moving unit that moves the condensing lens.

9. The laser processing apparatus according to claim 3, wherein the condensing position shifting unit has a condensing lens moving unit that moves the condensing lens.

10. The laser processing apparatus according to claim 7, wherein the condensing position shifting unit has a condensing lens moving unit that moves the condensing lens.

11. The laser processing apparatus according to claim 2, further comprising:
a laser source that emits the laser beam; and
an optical system that guides the laser beam emitted from the laser source to the condensing lens,
wherein the condensing position shifting unit has an optical element moving unit that moves an optical element of the optical system.

12. The laser processing apparatus according to claim 3, further comprising:
a laser source that emits the laser beam; and
an optical system that guides the laser beam emitted from the laser source to the condensing lens,
wherein the condensing position shifting unit has an optical element moving unit that moves an optical element of the optical system.

13. The laser processing apparatus according to claim 4, further comprising:
a laser source that emits the laser beam; and
an optical system that guides the laser beam emitted from the laser source to the condensing lens,
wherein the condensing position shifting unit has an optical element moving unit that moves an optical element of the optical system.

14. The laser processing apparatus according to claim 7, further comprising:
a laser source that emits the laser beam; and
an optical system that guides the laser beam emitted from the laser source to the condensing lens,
wherein the condensing position shifting unit has an optical element moving unit that moves an optical element of the optical system.

15. The laser processing apparatus according to claim 8, further comprising:
a laser source that emits the laser beam; and
an optical system that guides the laser beam emitted from the laser source to the condensing lens,
wherein the condensing position shifting unit has an optical element moving unit that moves an optical element of the optical system.

16. The laser processing apparatus according to claim 9, further comprising:
a laser source that emits the laser beam; and
an optical system that guides the laser beam emitted from the laser source to the condensing lens,
wherein the condensing position shifting unit has an optical element moving unit that moves an optical element of the optical system.

17. The laser processing apparatus according to claim 10, further comprising:
a laser source that emits the laser beam; and
an optical system that guides the laser beam emitted from the laser source to the condensing lens,
wherein the condensing position shifting unit has an optical element moving unit that moves an optical element of the optical system.
